(19) United States
(12) Patent Application Publication
(10) Pub. No.: US 2018/0232202 A1
(43) Pub. Date: Aug. 16, 2018

(54) KITCHEN SUPPORT SYSTEM

(71) Applicant: Panasonic Intellectual Property Management Co., Ltd., Osaka (JP)

(72) Inventors: JUNICHI TAGAWA, Tokyo (JP); YUUSAKU SHIMAOKA, Osaka (JP); TAKAYUKI MOHRI, Tokyo (JP)

(21) Appl. No.: 15/881,832

(22) Filed: Jan. 29, 2018

(30) Foreign Application Priority Data
Feb. 10, 2017 (JP) 2017-023325

(51) Int. Cl. G06F 3/16; G10L 15/22; G06K 9/00; G09B 19/00; G09B 5/02

(52) U.S. Cl. CPC G06F 3/167; G10L 15/22; G10L 13/043; G09B 19/0092; G09B 5/02; G06K 9/00771

(57) ABSTRACT

A kitchen support system includes a projector, a voice recognizer, and a controller. The projector projects an image toward a cooking space in which cooking is performed. The voice recognizer recognizes content of voice which is input. The controller controls the projector to project a dish relating image including an order display image indicating order content of dish, and changes the dish relating image which is projected by the projector in accordance with recognition results of the voice recognizer.

### BACKGROUND

### 1. Technical Field

The present disclosure relates to a kitchen support system and particularly to a kitchen support system that displays order content of dish.

### 2. Description of the Related Art

Japanese Patent Unexamined Publication No. 2002-342440 (PTL 1) discloses a kitchen video system used in a restaurant and the like. The kitchen video system of PTL 1 includes an electronic cash register having a function of sending a registered object to a display controller, and a display controller having a function of displaying an object transmitted from the electronic cash register. The display controller displays order contents on a plurality of monitors, and the plurality of monitors are installed in a cooking place where cooking of dish is performed, an assortment place where cooked dishes are assorted, and the like.

### SUMMARY

A kitchen support system includes a projector, a voice recognizer, and a controller.

The projector projects an image toward a cooking space in which cooking is performed.

The voice recognizer recognizes content of voice which is input.

The controller controls the projector to project a dish relating image including an order display image indicating order content of dish, and changes the dish relating image which is projected by the projector in accordance with recognition results of the voice recognizer.

### BRIEF DESCRIPTION OF THE DRAWINGS

FIG. 1 is a block diagram of a kitchen support system according to an exemplary embodiment;

FIG. 2 is a perspective view of the kitchen support system according to the exemplary embodiment;

FIG. 3 is a side surface view of the kitchen support system according to the exemplary embodiment;

FIG. 4A is an explanatory view of an operation of displaying order content in the kitchen support system according to the exemplary embodiment;

FIG. 4B is an explanatory view of the operation of displaying the order content in the kitchen support system according to the exemplary embodiment;

FIG. 5A is an explanatory view of the operation of displaying the order content in the kitchen support system according to the exemplary embodiment;

FIG. 5B is an explanatory view of the operation of displaying the order content in the kitchen support system according to the exemplary embodiment;

FIG. 6A is an explanatory view of the operation of displaying the order content in the kitchen support system according to the exemplary embodiment;

FIG. 6B is an explanatory view of the operation of displaying the order content in the kitchen support system according to the exemplary embodiment;

FIG. 7A is an explanatory view of an operation of displaying a cooking sequence in the kitchen support system according to the exemplary embodiment;

FIG. 7B is an explanatory view of the operation of displaying the cooking sequence in the kitchen support system according to the exemplary embodiment.

FIG. 8A is an explanatory view of the operation of displaying the cooking sequence in the kitchen support system according to the exemplary embodiment;

FIG. 8B is an explanatory view of the operation of displaying the cooking sequence in the kitchen support system according to the exemplary embodiment.

FIG. 9A is an explanatory view of the operation of displaying the cooking sequence in the kitchen support system according to the exemplary embodiment;

FIG. 9B is an explanatory view of the operation of displaying the cooking sequence in the kitchen support system according to the exemplary embodiment.

FIG. 10A is an explanatory view of the operation of displaying the cooking sequence in the kitchen support system according to the exemplary embodiment;

FIG. 10B is an explanatory view of the operation of displaying the cooking sequence in the kitchen support system according to the exemplary embodiment;

FIG. 11 is an explanatory view of the operation of displaying the cooking sequence in the kitchen support system according to the exemplary embodiment;

FIG. 12 is an explanatory view of a recorded image of a cooking process in the kitchen support system according to the exemplary embodiment;

FIG. 13A is an explanatory view of a state in which an auxiliary line for supporting a cutting work is projected in the kitchen support system according to the exemplary embodiment;

FIG. 13B is an explanatory view of a state in which an auxiliary line for determining a size of an ingredient is projected in the kitchen support system according to the exemplary embodiment;

FIG. 14A is an explanatory view of a state in which an image for supporting a dessert plating work is projected in the kitchen support system according to the exemplary embodiment; and

FIG. 14B is an explanatory view of a state in which an image for supporting creation of a latte art is projected in the kitchen support system according to the exemplary embodiment.

### DETAILED DESCRIPTION

In a kitchen video system of PTL 1, a cooking person confirms the order contents displayed on a monitor installed at a cooking place and does cooking. The monitor is installed on a wall or the like so as not to disturb a cooking work. Therefore, in a case where order content is confirmed during the cooking work, the cooking person has to move a line of sight between a cooking hand and the monitor on a wall surface, which may lower work efficiency.

The exemplary embodiment which will be described below is merely one of various embodiments according to the present disclosure. The exemplary embodiment according to the present disclosure is not limited to the following exemplary embodiment, and can include embodiments other than this exemplary embodiment. In addition, the following exemplary embodiment can be variously modified according to design and the like within a scope not departing from a technical idea according to the present disclosure.

### (1) Overview

A kitchen support system 1 according to the present exemplary embodiment is used, for example, in a cooking place of a fast food store.

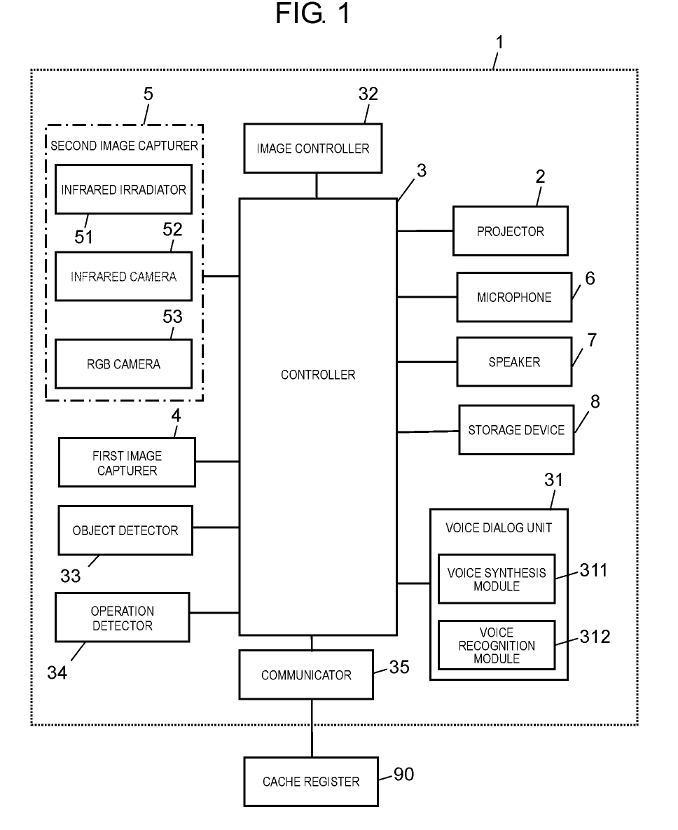

As illustrated in FIG. 1, kitchen support system 1 includes projector 2, voice recognition module (voice recognize′) 312, and controller 3. Projector 2 projects an image toward a cooking space where cooking is performed. Voice recognition module 312 recognizes content of an input voice. Controller 3 causes projector 2 to project a dish relating image relating to dish including an order display image indicating order content of the dish. Controller 3 changes the dish relating image projected by projector 2 according to recognition results of voice recognition module 312.

In kitchen support system 1, projector 2 projects the dish relating image including the order display image indicating the order content of the dish toward the cooking space where cooking is performed by the cooking person. The cooking person can grasp the order content of dish by viewing the dish relating image projected on the cooking space, and thereby, the amount of movement of a line of sight in a case where the order content is confirmed during cooking can be reduced and work efficiency can increase. In addition, since controller 3 changes the dish relating image projected by projector 2 according to recognition results of voice recognition module 312, the cooking person can change the dish relating image by voice. Thus, the cooking person can use both hands when changing the dish relating image, and thus, the work efficiency increases.

### (2) Details

Hereinafter, kitchen support system 1 according to the present exemplary embodiment will be described in detail with reference to FIGS. 1 to 14.

### (2.1) Configuration

As illustrated in FIG. 1, kitchen support system 1 includes projector 2, voice dialog unit 31, controller 3, first image capturer 4, second image capturer 5, microphone 6, speaker 7, and a storage device 8.

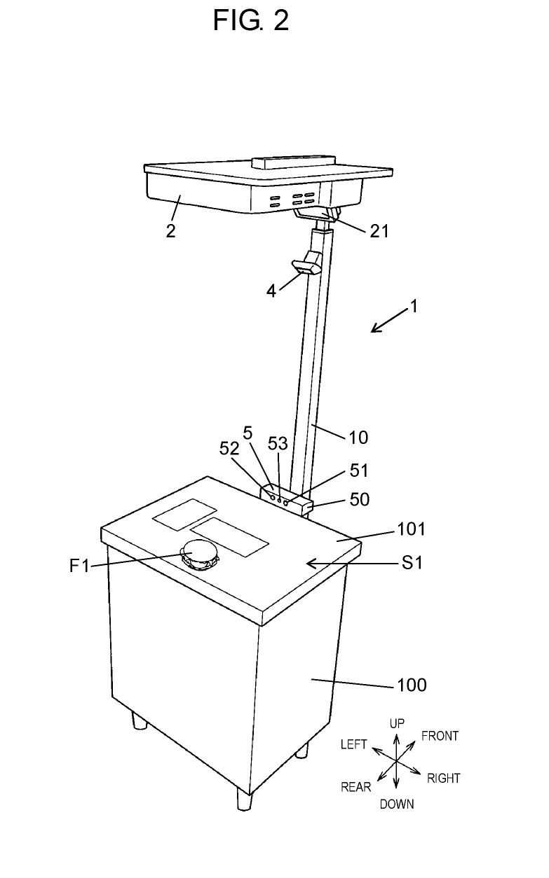

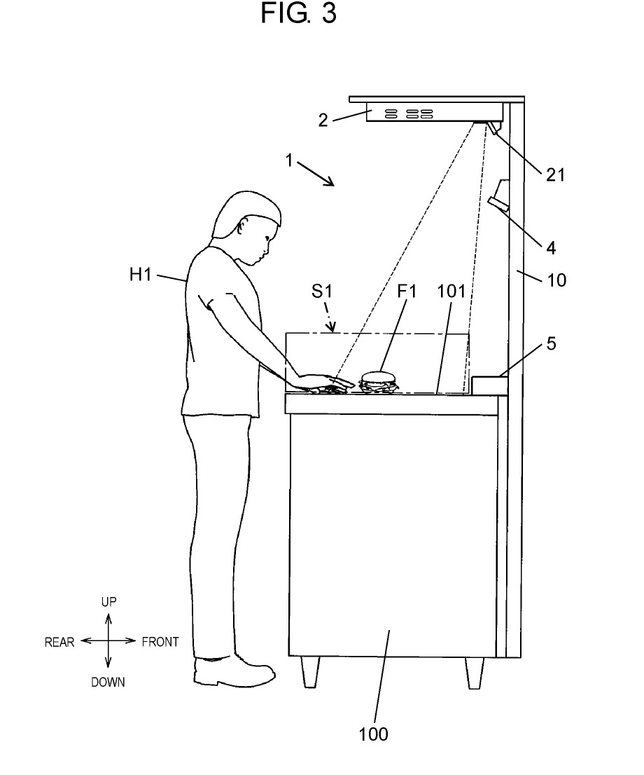

As illustrated in FIGS. 2 and 3, kitchen support system 1 is provided on cooking table 100 in which cooking person H1 cooks dish ordered from a customer. Hereinafter, directions are specified as indicated by arrows “up”, “down”, “left”, “right”, “front”, and “rear” in FIG. 2 and the like. That is, cooking person H1 who does cooking defines an up-down direction, a left-right direction, and a front-rear direction, based on a direction when cooking person H1 who does cooking views cooking space S1 (upper surface 101 of cooking table 100 and a space above an upper portion thereof), but the directions are not intended to specify directions at the time of using kitchen support system 1. The arrows indicating directions in the drawing are merely illustrated for explanation and do not involve entities.

Projector 2 is supported by support pillar 10 disposed on, for example, a front side of cooking table 100 and is disposed above cooking table 100. Projector 2 projects an image toward cooking space S1, that is, toward upper surface 101 of cooking table 100. In the present exemplary embodiment, projector 2 causes the projected image to be reflected by mirror 21, and thereby the image is projected onto the upper surface of cooking table 100, but the image may be directly projected onto the upper surface of cooking table 100. In addition, projector 2 may be provided integrally with cooking table 100.

First image capturer 4 is attached on an upper side of support pillar 10 such that an image of upper surface 101 (cooking space S1) of cooking table 100 can be captured from above. First image capturer 4 includes an image-capturing element such as a charge coupled device (CCD) image sensor, a complementary MOS (CMOS) image sensor, or the like. First image capturer 4 captures a color image of upper surface 101 of cooking table 100, but may be an image capturer that captures a monochrome image.

Second image capturer 5 is disposed near a front end of upper surface 101 of cooking table 100 so as to be able to capture an image of upper surface 101 of cooking table 100. Second image capturer 5 captures an image of a region including upper surface 101 of cooking table 100 and a space on an upper side thereof. Infrared irradiator 51, infrared camera 52, and RGB camera 53 are disposed on a front surface of case 50 of second image capturer 5 (see FIG. 2).

RGB camera 53 captures a two-dimensional color image of cooking space 51 at a predetermined frame rate (for example, 10 to 80 frames per second). Infrared irradiator 51 and infrared camera 52 configure a distance image sensor that measures a distance by using, for example, a time of flight (TOF) method. Infrared irradiator 51 irradiates cooking space S1 with infrared rays. Infrared camera 52 includes a light receiving element such as a CCD image sensor, a CMOS image sensor, or the like, and receives infrared light. Infrared camera 52 is disposed so as to face the same direction as RGB camera 53. Infrared camera 52 receives the reflected light obtained by reflecting the light irradiated from infrared irradiator 51 from an object (an ingredient, a cooking utensil, a hand of cooking person H1, or the like) located at cooking space S1. A distance to the object can be measured based on the time until the infrared light irradiated from infrared irradiator 51 is received by infrared camera 52. Thus, by combining the two-dimensional color image captured by RGB camera 53 and the distance to the object obtained by infrared irradiator 51 and infrared camera 52, a distance between the object located at cooking space S1 and infrared camera 52 can be obtained. Second image capturer 5 outputs the two-dimensional color image showing cooking space S1 and a depth image (distance image) including information on the distance to the object located at cooking space S1 to controller 3. Here, the depth image is a grayscale image in which the distance to the object is represented in grayscale.

Microphone 6 converts a sound such as a voice emitted from cooking person H1 into an electric signal and outputs the electric signal to controller 3.

Speaker 7 converts the electric signal input from controller 3 into a sound and outputs the sound.

Microphone 6 and speaker 7 may be attached to a main body of projector 2, support pillar 10, case 50 of second image capturer 5, cooking table 100, or the like. In addition, cooking person H1 may wear a head set provided with microphone 6 and speaker 7, and in this case, microphone 6, speaker 7, and controller 3 may perform a wireless communication by a short distance wireless method such as the Bluetooth (registered trademark).

Storage device 8 is an external storage device such as a hard disk or a memory card. Storage device 8 stores information on ingredients and a cooking sequence to be used for each of a plurality of dishes. In addition, storage device 8 stores an order display image projected by projector 2, a dish relating image such as a cooking instruction image, a recorded image obtained by capturing an image of a cooking sequence performed by cooking person H1, and the like. For example, in a case where cooking content of the dish changes or new dish is added, the information on the dish stored in storage device 8, a program executed by a computer system of controller 3 which will be described below, and the like may be updated, and it is possible to easily cope with a change in cooking content and addition of dish.

Controller 3 includes a computer system having a processor and a memory. As a program recorded in the memory of the computer system is executed by the processor of the computer system, functions of voice dialog unit 31, video controller 32, object detector 33, operation detector 34 and the like are realized. The program may be prerecorded in the memory, may be provided through an electric communication line such as the Internet, or may be provided by being recorded in a recording medium such as a memory card. In addition, controller 3 includes a communicator 35.

Voice dialog unit 31 includes voice synthesis module 311 and voice recognition module 312. Voice synthesis module 311 synthesizes voices by using a synthesis method such as waveform-connection type voice synthesis, formant synthesis, and the like, and outputs the synthesized voice from speaker 7. Voice recognition module 312 recognizes content of voice input to microphone 6 using, for example, a hidden Markov model. Voice dialog unit 31 performs voice dialog by using voice synthesis module 311 and voice recognition module 312.

Image controller 32 controls an operation of projector 2 projecting an image toward cooking space S1. Image controller 32 causes projector 2 to project a dish relating image relating to the dish.

The dish relating image includes an order display image indicating order content of dish. Image controller 32 may control projector 2 to project the order display image on a region where an object is not placed in cooking space S1. In a case where a plurality of dishes are ordered, image controller 32 may control projector 2 to project the order display image indicating the order contents of the plurality of dishes onto cooking space S1. In addition, detailed contents of the ordered dish may be displayed in the order display image. For example, dish ordered by a customer includes dish (hereinafter, referred to as a basic menu) whose content is determined by a store, and dish (hereinafter, referred to as a custom menu) in which content of the basic menu is partially changed according to an individual order of a customer. The custom menu is, for example, dish in which an additional ingredient is added to the basic menu, or dish in which a part of the ingredients (including seasonings) contained in the basic menu is reduced or increased or removed.

In addition, the dish relating image may include a cooking instruction image instructing the cooking person a dish cooking method. When object detector 33 which will be described below detects an ingredient placed in cooking space S1, image controller 32 may control projector 2 to project the cooking instruction image onto the ingredient.

Object detector 33 detects an object (an ingredient, a cooking utensil, a hand of cooking person H1, or the like) in cooking space S1 by using an image captured by RGB camera 53 and an image captured by infrared camera 52. Object detector 33 detects an object not reflected in a background image, for example, by performing background differentiation between the image captured by RGB camera 53 and a background image. In addition, object detector 33 can obtain a distance to the object based on a distance image captured by infrared camera 52. Thus, object detector 33 can obtain a distance between an object in cooking space S1 and infrared camera 52 by using the image captured by RGB camera 53 and the image captured by infrared camera 52.

Operation detector 34 detects an operation of cooking person H1, for example, an operation performed by a hand of cooking person H1. In a case where object detector 33 detects the hand of cooking person H1, operation detector 34 traces a motion of the hand of cooking person H1 thereby detecting the operation (gesture) performed by cooking person H1.

Communicator 35 communicates with cash register 90 installed in, for example, a counter or the like of a fast-food store. Communicator 35 includes, for example, a communication module conforming to a communication standard of the Ethernet (registered trademark). If a person in charge who operates cash register 90 receives an order for dish from a customer and inputs a dish order into cash register 90, cash register 90 performs settlement processing of the input dish. In addition, cash register 90 transmits order information indicating order content of the dish input by a store clerk to kitchen support system 1, and the order information is received by communicator 35.

### (2.2) Operation

An operation of kitchen support system 1 according to the present exemplary embodiment will be described with reference to the drawings.

### (2.2.1) Display Operation of Order Content

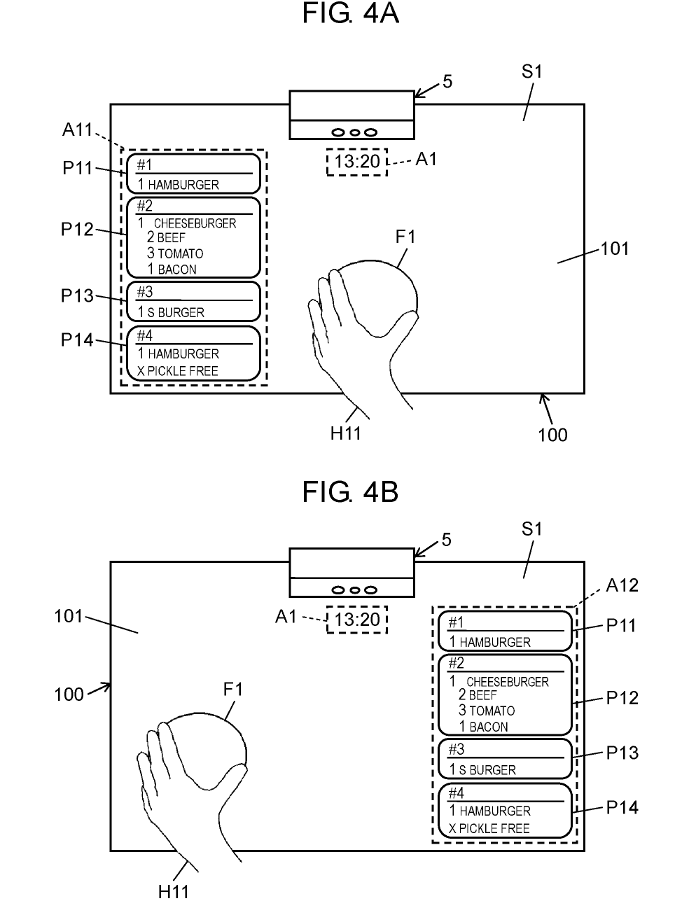

A display operation in which kitchen support system 1 according to the present exemplary embodiment projects dish order content onto cooking space S1 will be described with reference to FIGS. 4A to 6B.

In a case where cooking is performed by using kitchen support system 1, the cooking person utters a word representing identification information (for example, a name or an ID number) of the cooking person toward microphone 6. The word uttered by the cooking person is converted into an electric signal by microphone 6, is input to controller 3, and voice recognition is performed by voice recognition module 312. Controller 3 counts cumulative work time for each cooking person, based on the identification information input by the cooking person and uses the cumulative work time for estimating, for example, a skill level of a cooking work.

In addition, if communicator 35 of controller 3 receives the order information from cash register 90, image controller 32 creates an order display image indicating order content of dish, based on the order information, and projects the order display image toward cooking space S1 by controlling projector 2. FIG. 4A illustrates order display images P11 to P14 projected onto upper surface 101 of cooking table 100 which is cooking space S1. On upper surface 101 of cooking table 100, order display images P11 to P14 are displayed in region A11 on the left side and a current time is displayed in region A1 on the front side in a central portion in the left-right direction. Time elapsed from a point of time when cooking starts may be displayed in region A1. In FIGS. 4A to 6B, regions A1, A11, and A12 where an image is projected are indicated by dotted lines, but dotted lines and symbols indicating the regions are not projected. In addition, order display images P11 to P14 illustrated in FIG. 4A and the like are merely examples, and contents of order display images P11 to P14 can be appropriately changed depending on a request or the like of a user of kitchen support system 1.

Each of order display images P11 to P14 indicates ordered dish, order numbers (#1, #2, #3, and #4) are displayed on a front side within a rectangular frame, and names of dishes (for example, hamburger, cheeseburger, S burger) and the like are displayed on a rear side (front side) of the order numbers. Image controller 32 generates an image in which a plurality of order display images P11 to P14 are aligned in a sequence in which the order numbers decreases toward a front side of region A11, and causes projector 2 to project the image. In a case where the ordered dish is the custom menu, change contents (for example, an ingredient to be added, an ingredient to be removed, and the like) from the basic menu are displayed under the dish name.

As described above, since order display images P11 to P14 representing the order contents of dishes whose ordered cooking is not completed are displayed on upper surface 101 of cooking table 100, cooking person H1 can confirm dishes whose cooking is not completed based on order display images P11 to P14. Moreover, since order display images P11 to P14 are displayed on upper surface 101 of cooking table 100, the amount of movement of a line of sight between a cooking hand and order display images P11 to P14 can be reduced, and work efficiency can increase.

Here, object detector 33 of controller 3 detects an object in cooking space S1, for example, an object placed on upper surface 101 of cooking table 100 and an object (hand H11 or the like of the cooking person) existing above upper surface 101 of cooking table 100 are detected. Image controller 32 controls projector 2 such that order display images P11 to P14 are projected onto a region (region where ingredient F1, hand H11 of the cooking person, and the like are not exist in FIG. 4A) where an object does not exist on upper surface 101 of cooking table 100, based on the detection results of object detector 33. As illustrated in FIG. 4B, if the cooking person moves ingredient F1 to a region on the left side of upper surface 101 of cooking table 100, image controller 32 controls projector 2 such that order display images P11 to P14 are projected onto region A12 on the right side of upper surface 101, based on the detection results of object detector 33. As described above, since order display images P11 to P14 are not projected onto the object, the display contents of order display images P11 to P14 are easily seen.

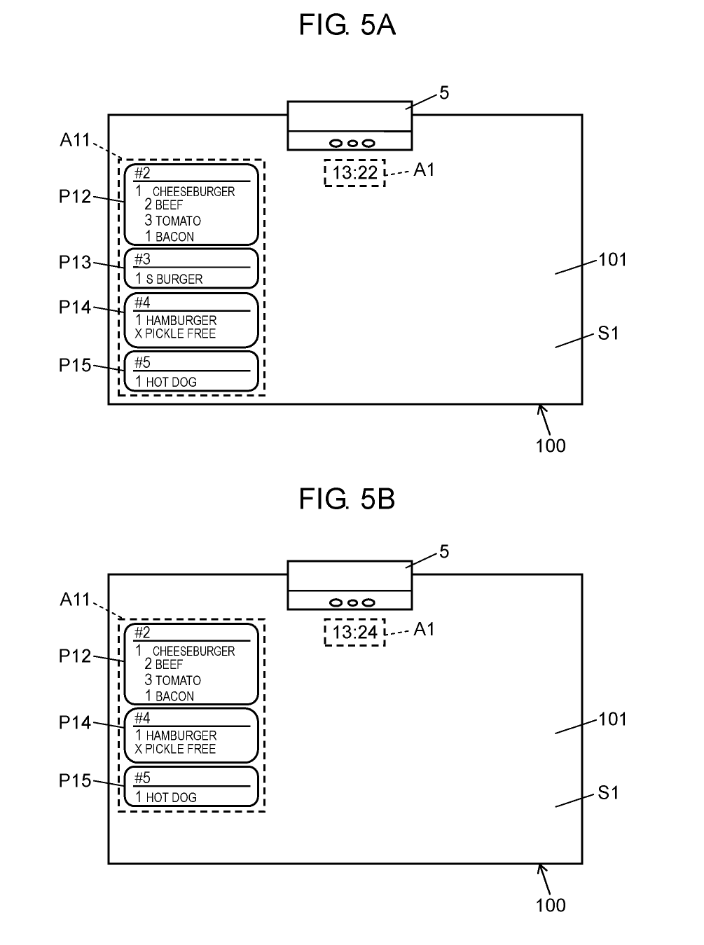

If cooking of dish whose order number is 1 is completed, cooking person H1 utters a word indicating that cooking of the first dish is completed, for example “first dish completion”. The word uttered by cooking person H1 is converted into an electric signal by microphone 6 and is input to controller 3, and voice recognition is performed by voice recognition module 312. If it is determined that that cooking of the first dish is completed based on the recognition results of voice recognition module 312, image controller 32 deletes order display image P11 corresponding to the first dish from region A11, as illustrated in FIG. 5A. Since cooking person H1 inputs instructions by voice, there is no need to manually operate buttons or the like to input the instructions, and it is hygienic because it is not necessary to touch the buttons. In addition, since cooking person H1 can input the instruction by voice, work can be performed by both hands during that time, and thus, work efficiency increases. The word that cooking person H1 uses for instructing by voice is an example, and can be appropriately modified.

Image controller 32 causes projector 2 to project order display images P12 to P15 corresponding to second dish to fifth dish whose cooking is not completed, onto region A11. The number of dishes that can be displayed on upper surface 101 of cooking table 100 is limited, and an order display image of the dish whose order number is 5 is not projected in FIG. 4A. If the cooking of the dish whose order number is 1 is completed, image controller 32 causes projector 2 to project order display images P12 to P15 of the second dish to fifth dish onto region A11, as illustrated in FIG. 5A.

If cooking of the dish whose order number is 3 is completed, cooking person H1 utters a word indicating that the cooking of the third dish is completed, for example, “third dish completion”. The word uttered by cooking person H1 is converted into an electric signal by microphone 6 and is input to controller 3, and voice recognition is performed by voice recognition module 312. If it is determined that cooking of the third dish is completed based on the recognition results of voice recognition module 312, image controller 32 deletes order display image P13 corresponding to the third dish from region A11 as illustrated in FIG. 5B. Image controller 32 causes projector 2 to project order display images P12, P14, and P15 respectively corresponding to the second dish, the fourth dish, and the fifth dish whose cooking is not completed onto region A11.

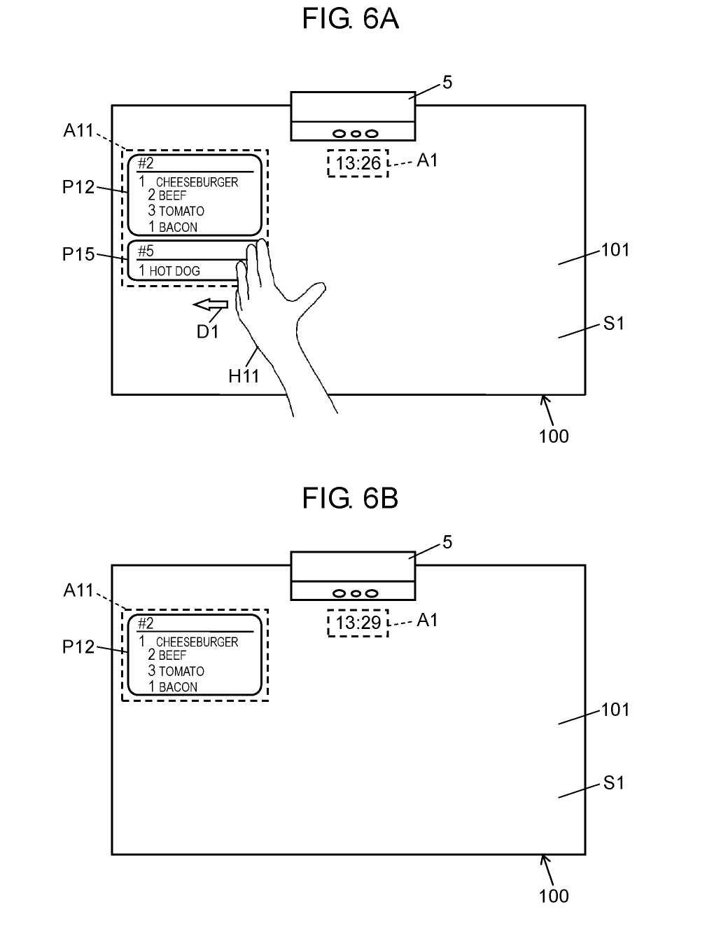

If cooking of the dish whose order number is 4, cooking person H1 utters a word indicating that cooking of the fourth dish is completed, for example “fourth dish completion”. The word uttered by cooking person H1 is converted into an electric signal by microphone 6 and is input to controller 3, and voice recognition is performed by voice recognition module 312. If it is determined that cooking of the fourth dish is completed, based on the recognition results of voice recognizer 312, image controller 32 deletes order display image P14 corresponding to the fourth dish from region A11 as illustrated in FIG. 6A. Image controller 32 causes projector 2 to project order display images P12 and P15 respectively corresponding to the second dish and the fifth dish whose cooking is not completed onto region A11.

However, the method by which cooking person H1 inputs completion of cooking to controller 3 is not limited to voice. Cooking person H1 may input the completion of the cooking to controller 3 by a predetermined operation. Object detector 33 of controller 3 detects an object in cooking space S1, based on the images captured by infrared camera 52 and RGB camera 53. In a case where the object detected by object detector 33 is hand H11 of a person (here, the cooking person), operation detector 34 traces a motion of hand H11 thereby detecting an operation performed by the cooking person. In a case where the operation of the cooking person detected by operation detector 34 is a preset operation, controller 3 changes the image projected by projector 2, according to the operation. For example, an operation of sliding hand H11 in a lateral direction (direction toward the outside of cooking space S1) from a projection position of the order display image on upper surface 101 of cooking table 100 is set to controller 3 as an operation of inputting completion of cooking. As illustrated in FIG. 6A, in a case where cooking of the fifth dish is completed in a state where order display images P12 and P15 are projected on the left side of upper surface 101 of cooking table 100, the cooking person performs the following operation to input completion of cooking of the fifth dish. After moving hand H11 to the projection position of order display image P15, the cooking person slides hand H11 to the left side (a direction to a closer one of right and left ends of upper surface 101 from a projected position of order display image P15, a direction of arrow DD. If the cooking person performs such an operation, controller 3 determines that cooking of the fifth dish is completed based on the detection results of operation detector 34, and deletes order display image P15 of the fifth dish from region A11 as illustrated in FIG. 6B. Image controller 32 causes projector 2 to project order display image P12 corresponding to the second dish whose cooking is not completed onto region A11. The operation for inputting the completion of cooking is not limited to the above-described operation, and may be an operation that the cooking person touches the projection position of the order display image of dish whose cooking is completed on upper surface 101 of cooking table 100 by hand.

Thereafter, if cooking person H1 completes cooking of the dish whose order number is 2, cooking person H1 utters a word indicating that cooking of the second dish is completed, for example, “second dish completion”. The word uttered by cooking person H1 is converted into an electric signal by microphone 6 and is input to controller 3, and voice recognition is performed by voice recognition module 312. If it is determined that cooking of the second dish is completed based on the recognition results of voice recognition module 312, image controller 32 deletes order display image P12 corresponding to the second dish. Here, if all the dishes that are ordered are cooked, image controller 32 of controller 3 does not cause projector 2 to project the order display image and the order display image is not displayed on upper surface 101 of cooking table 100, and thus, the cooking person can confirm that there is no dish waiting for cooking.

### (2.2.2) Display Operation of Cooking Sequence

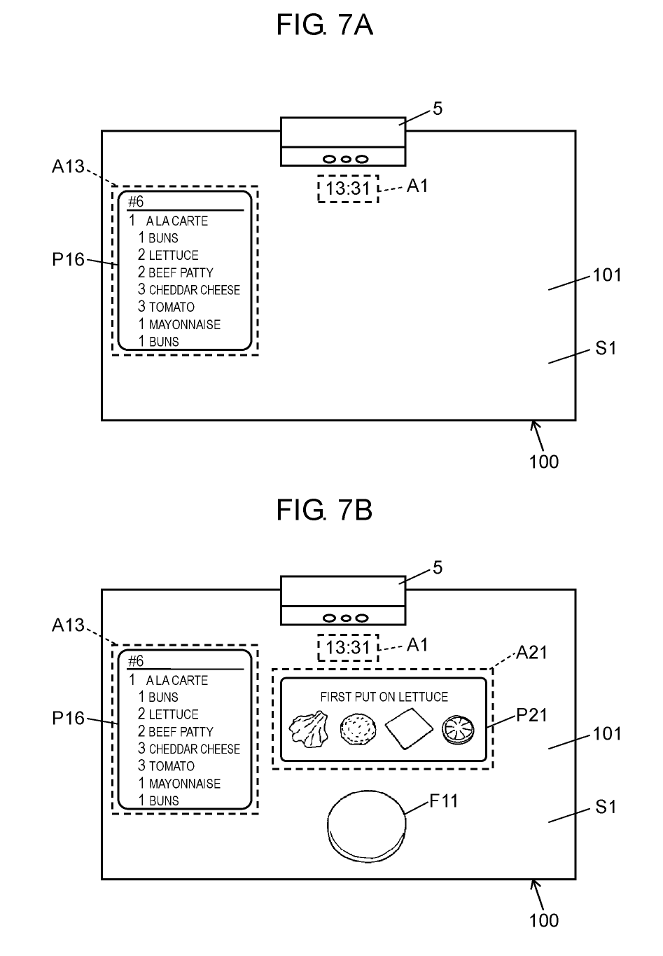

A display operation in which kitchen support system 1 according to the present exemplary embodiment projects a cooking sequence of dish onto cooking space S1 will be described with reference to FIGS. 7A to 11.

There are the basic menu and the custom menu for ordering dishes received from a customer, and contents of dishes differ from each other for each article in a case of the custom menu, and thus, a cooking person may be perplexed in the cooking sequence. In addition, a cooking person who is not skillful may be perplexed in the cooking sequence even with the basic menu.

Therefore, in kitchen support system 1 according to the present exemplary embodiment, it is possible for projector 2 to project the cooking sequence of dishes (basic menu, custom menu, and the like) onto cooking space S1.

If communicator 35 of controller 3 receives order information of dishes from cash register 90, controller 3 reads ingredients to be used and the cooking sequence of the ordered dish from storage device 8, based on the order information. In a case where the ordered dish is the custom menu, controller 3 reads the ingredient to be used and the cooking sequence in the basic menu becoming the origin of the custom menu from storage device 8, and creates the ingredients and the cooking sequence of the custom menu by reflecting the individual order of the customer.

As illustrated in FIG. 7A, image controller 32 of controller 3 projects order display image P16 indicating order content of dish onto region A13 on the left side of upper surface 101 of cooking table 100. In order display image P16, an order number (#6) is displayed on the front side of a rectangular frame, and a name (a la carte) of dish and a list of ingredients to be used (including seasoning) for the dish are displayed on the rear side (front side) of the order number. The ingredients to be used are displayed in the list of ingredients to be used, in the order in which the ingredients are used. In the example of FIG. 7A, buns, lettuce, beef patty, cheddar cheese, tomato, mayonnaise, and buns are listed as ingredients to be used for cooking sequentially from the top.

In a case where display of the cooking sequence is requested, a cooking person utters “help” following the name of dish (a la carte), for example, like “a la carte”. The word uttered by the cooking person is converted into an electric signal by microphone 6 and is input to controller 3, and voice recognition is performed by voice recognition module 312. If it is determined that the display of a cooking sequence is requested, image controller 32 starts an operation of projecting the display sequence onto cooking space S1 (upper surface 101 of cooking table 100), based on the recognition results of voice recognition module 312. If receiving an instruction uttered by the cooking person as a word, controller 3 may output a sound such as a beep sound from speaker 7 and notify the cooking person that the instruction of the cooking person is received.

Image controller 32 causes projector 2 to project cooking instruction image P21 (refer to FIG. 7B) instructing the cooking person the cooking sequence in region A21 on the front side of time display region A1 on upper surface 101 of cooking table 100. In the example of FIG. 7B, a message (for example, “first, put on lettuce”) for instructing cooking content with letters and an image of ingredients to be used in the dish are displayed on cooking instruction image P21. In addition, ingredients of a work target in cooking instruction image P21 are displayed to be surrounded by a circle, and the same applies to other cooking instruction images P22 to P25 which will be described below.

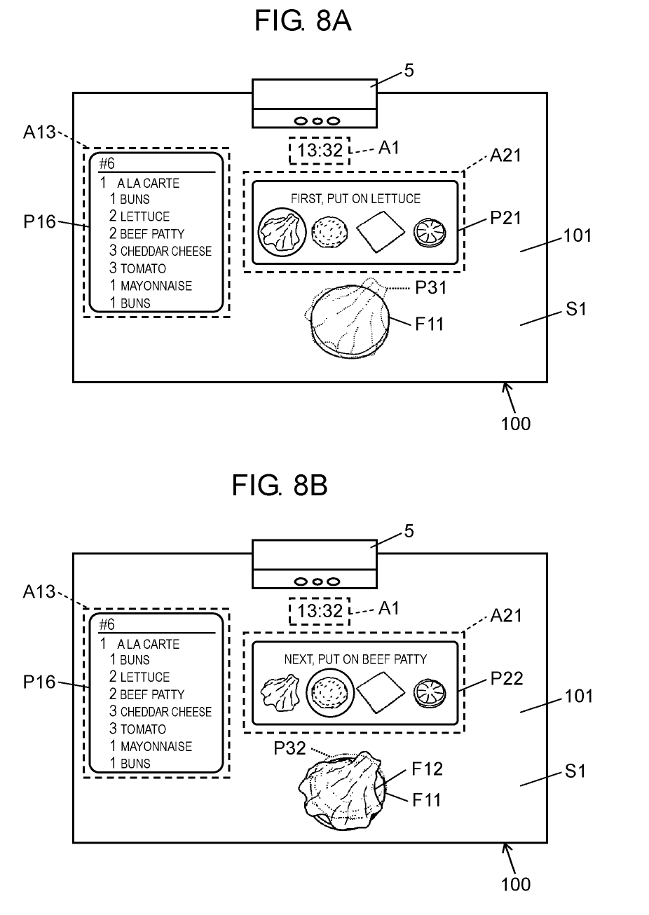

As illustrated in FIG. 7B, if the cooking person places buns F11 on upper surface 101 of cooking table 100, object detector 33 detects buns F11 placed on upper surface 101 of cooking table 100 and a position thereof. If object detector 33 detects buns F11, image controller 32 controls projector 2 image P31 of lettuce which will be put on next is projected onto buns F11 (refer to FIG. 8A). In addition, controller 3 may synthesize voice with “first, put on lettuce” in voice synthesis module 311 and outputs synthesized voice from speaker 7. Since projector 2 projects an image of ingredients to be placed next on the ingredients actually placed, the cooking person easily understand the next work, and thus, work efficiency increases.

If it is determined that display of the cooking sequence is requested based on the recognition results of voice recognition module 312, image controller 32 may project the ingredients that the cooking person first puts, here, before placing buns F11, onto a predetermined position on upper surface 101 of cooking table 100. There is an advantage that the cooking person who sees the image may not detect a position of buns F11 because buns F11 is placed on the image of the buns.

In FIGS. 8A to 11, ingredients F11 to F17 actually placed on upper surface 101 of cooking table 100 are denoted by a solid line, and images P31 to P35 projected onto the ingredients are denoted by a dotted line. It is preferable that image controller 32 changes a size and a display position of order display image P16, cooking instruction image P21, and a time image so as not to overlap with buns F11. Image controller 32 changes the display position of order display image P16, cooking instruction image P21, and the time image so as not to overlap with the ingredients, and thereby, the sizes of order display image P16, cooking instruction image P21, and the time image can be enlarged as large as possible, and the display content is easily viewed.

As illustrated in FIG. 8B, the cooking person places lettuce F12 at the position (that is, above buns F11) of image P31 of the lettuce projected onto buns F11 and utters a word for requesting display of the next sequence like, for example, “next”. The word uttered by the cooking person is converted into an electric signal by microphone 6 and is input to controller 3, and voice recognition is performed by voice recognition module 312. In addition, object detector 33 detects lettuce F12 placed on buns F11 and a position thereof. If it is determined that display of the next cooking sequence is requested based on the recognition results of voice recognition module 312, image controller 32 causes projector 2 to project cooking instruction image P22 instructing the cooking person the next cooking sequence onto region A21. A message (for example, “next, put on beef patty”) for instructing cooking content with letters is displayed in cooking instruction image P22. Image controller 32 of controller 3 causes projector 2 to project image P32 of beef patty to be put on next onto lettuce F12. In addition, controller 3 may synthesize voice with “next, put on beef patty” in voice synthesizing module 311, and output the synthesized voice from speaker 7.

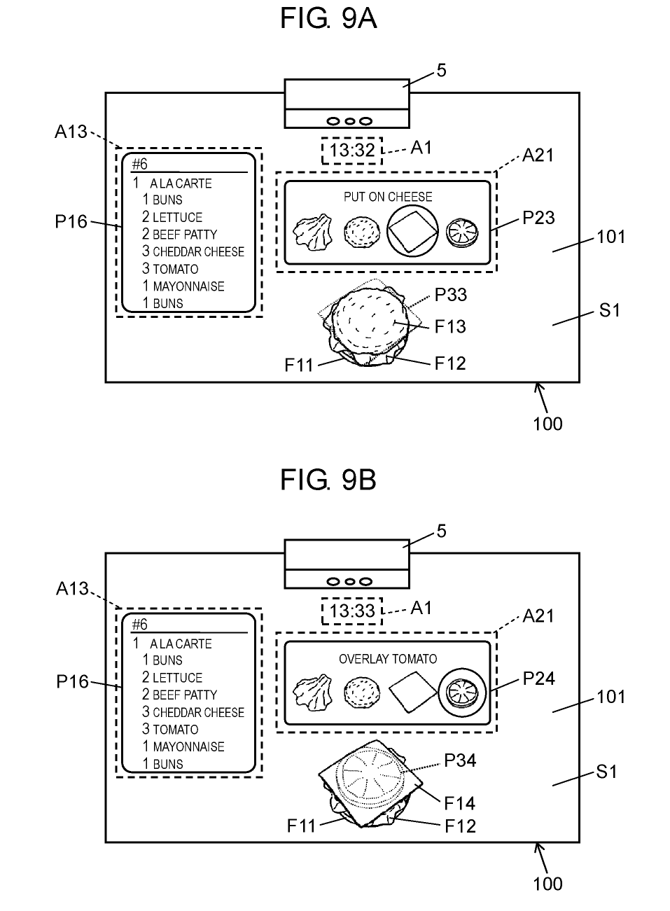

As illustrated in FIG. 9A, the cooking person places beef patty F13 at a position (that is, on lettuce F12) of image P32 of the beef patty projected onto lettuce F12 and utters a word requesting display of next sequence like, for example, “next”. The word uttered by the cooking person is converted into an electric signal by microphone 6 and is input to controller 3, and voice recognition is performed by voice recognition module 312. In addition, object detector 33 detects beef patty F13 placed on lettuce F12 and a position thereof. If it is determined that display of the next cooking sequence is requested based on the recognition results of voice recognition module 312, image controller 32 causes projector 2 to project cooking instruction image P23 instructing the cooking person the next cooking sequence onto region A21. A message (for example, “put on cheese”) for instructing cooking content with letters is displayed in cooking instruction image P23. Image controller 32 of controller 3 causes projector 2 to project image P33 of cheese to be put on next onto beef patty F13. In addition, controller 3 may synthesize voice with “put on cheese” in voice synthesizing module 311 and output the synthesized voice from speaker 7.

As illustrated in FIG. 9B, the cooking person places cheese F14 at a position (that is, on beef patty F13) of image P33 of the cheese projected onto beef patty F13, and utters a word requesting display of the next sequence like, for example, “next”. In addition, object detector 33 detects cheese F14 placed on beef patty F13 and a position thereof. The word uttered by the cooking person is converted into an electric signal by microphone 6 and is input to controller 3, and voice recognition is performed by voice recognition module 312. If it is determined that display of the next cooking sequence is requested based on the recognition results of voice recognition module 312, image controller 32 causes projector 2 to project cooking instruction image P24 instructing the cooking person the next cooking sequence onto region A21. A message (for example, “overlay tomato”) for instructing cooking content with letters is displayed in cooking instruction image P24. Image controller 32 of controller 3 causes projector 2 to project image P34 to be put on next onto cheese F14. In addition, controller 3 may synthesize voice with “overlay tomato” in voice synthesis module 311 and output the synthesized voice from speaker 7.

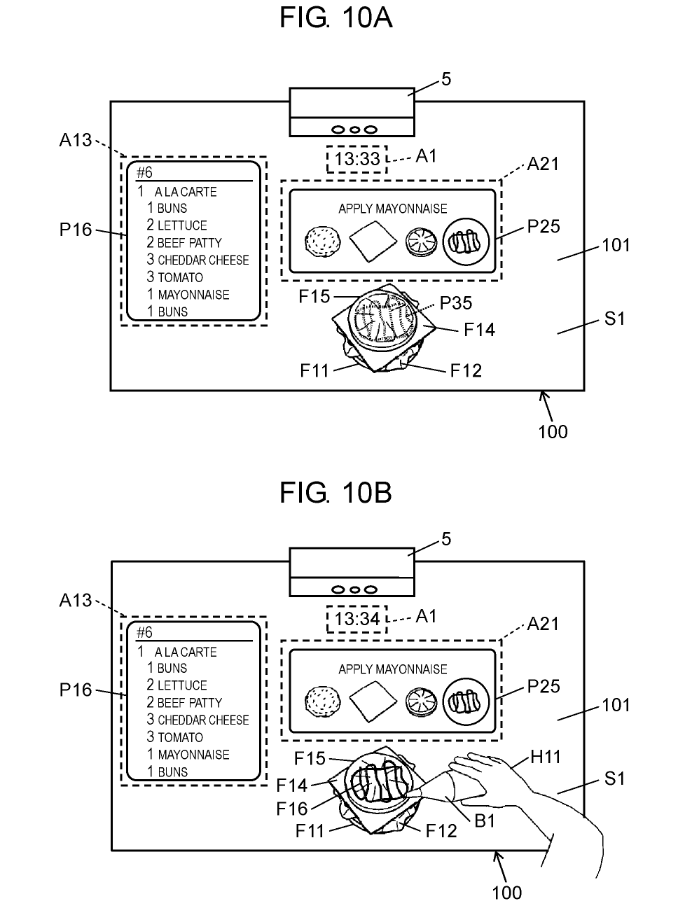

As illustrated in FIG. 10A, the cooking person places tomato F15 at a position (that is, on cheese F14) of image P34 of the tomato projected onto cheese F14 and utters a word requesting display of the next sequence like, for example, “next”. In addition, object detector 33 detects tomato F15 placed on cheese F14 and a position thereof. The word uttered by the cooking person is converted into an electric signal by microphone 6 and is input to controller 3, and voice recognition is performed by voice recognition module 312. If it is determined that display of the next cooking sequence is requested based on the recognition results of voice recognition module 312, image controller 32 causes projector 2 to project cooking instruction image P25 instructing the cooking person the next cooking sequence onto region A21. A message (for example, “apply mayonnaise”) for instructing cooking content with letters is displayed in cooking instruction image P25. Image controller 32 of controller 3 causes projector 2 to project an image of mayonnaise applied onto tomato F15 onto tomato F15. In addition, controller 3 may synthesize voice with “mayonnaise is applied” in voice synthesis module 311 and output the synthesized voice from speaker 7.

As illustrated in FIG. 10B, the cooking person moves bottle B1 so as to trace mayonnaise image P35 projected onto tomato F15 and puts mayonnaise F16 on tomato F15. As described above, the cooking person actually applies mayonnaise F16 while watching image P34 on which mayonnaise is applied, and thereby, the amount of mayonnaise F16 rarely varies, and mayonnaise F16 can be applied onto tomato F15 as a whole, and thus, it is possible to reduce variation in quality.

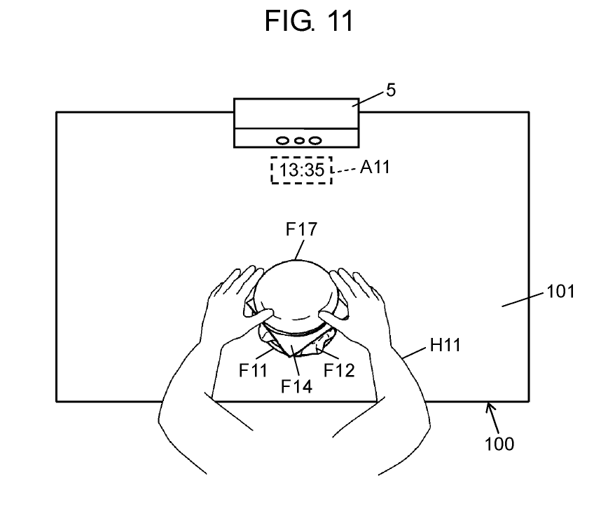

As illustrated in FIG. 11, the cooking person finally places buns F17 and utters a word indicating that cooking of the sixth dish is completed, for example “sixth dish completion”. The word uttered by cooking person H1 is converted into an electric signal by microphone 6 and is input to controller 3, and voice recognition is performed by voice recognition module 312. If it is determined that cooking of the sixth dish is completed based on the recognition results of voice recognition module 312, image controller 32 deletes order display image P16 corresponding to the sixth dish and cooking instruction image P25 as illustrated in FIG. 11, and controller 3 ends the display operation of the cooking sequence.

As described above, since kitchen support system 1 projects an image displaying a cooking sequence by letters onto cooking space S1 from projector 2, even a cooking person who are not skillful in cooking can easily cook, and it is possible to reduce variation in quality due to the cooking person. In addition, since kitchen support system 1 projects cooking instruction images (P21 to P25 and P31 to P35) indicating the next cooking sequence onto cooking space S1 (on upper surface 101 of cooking table 100 or on ingredients), the cooking person may do cooking according to the cooking instruction image. Thus, the cooking person can easily understand the next cooking work, and it is possible to increase skill of the cooking person and to increases work efficiency.

### (2.2.3) Recording Operation of Cooking Sequence

Kitchen support system 1 according to the present exemplary embodiment includes first image capturer 4 that captures an image of cooking space S1 from an upper side and can record a record image captured by first image capturer 4 in storage device 8.

Kitchen support system 1 according to the present exemplary embodiment includes voice interaction unit 31, but may include at least voice recognition module 312. Voice synthesis module 311 is not indispensable for kitchen support system 1 and can be omitted as appropriate. Instead of causing voice synthesis module 311 to output a voice message synthesized by voice synthesis module 311 from speaker 7, kitchen support system 1 may project an image indicating content of the voice message by letters onto projector 2. In addition, if an instruction from the cooking person is input by voice, an operation, or the like, kitchen support system 1 may cause speaker 7 to output a notification sound such as a beep sound indicating that an instruction is received.

In a case where one article of dish is cooked, controller 3 causes first image capturer 4 to capture an image of cooking space S1 from an upper side at a plurality of stages from the start to the end of cooking. For example, in a case of a hamburger made by stacking a plurality of ingredients, first image capturer 4 may capture an image of cooking space S1 every time new ingredients are stacked. Controller 3 causes storage device 8 to store the record image captured by first image capturer 4 in association with time information of the record image and identification information of the cooking person. Here, the time information of the record image may include at least one piece of information among an image-captured date (that is, a cooking date) when the record image is captured, image-captured time (that is, cooking time), and elapsed time since cooking started. Storage device 8 may store the record image of cooking that the cooking person does in a folder created for each cooking person.

If a user (such as a cooking person) of kitchen support system 1 designates the cooking person, dish of a display target, the cooking date, and the like and instructs an output of the record image by voice or the like, controller 3 extracts the record image corresponding to the designated condition from storage device 8. Controller 3 causes projector 2 to project the record image extracted from storage device 8 onto upper surface 101 of cooking table 100.

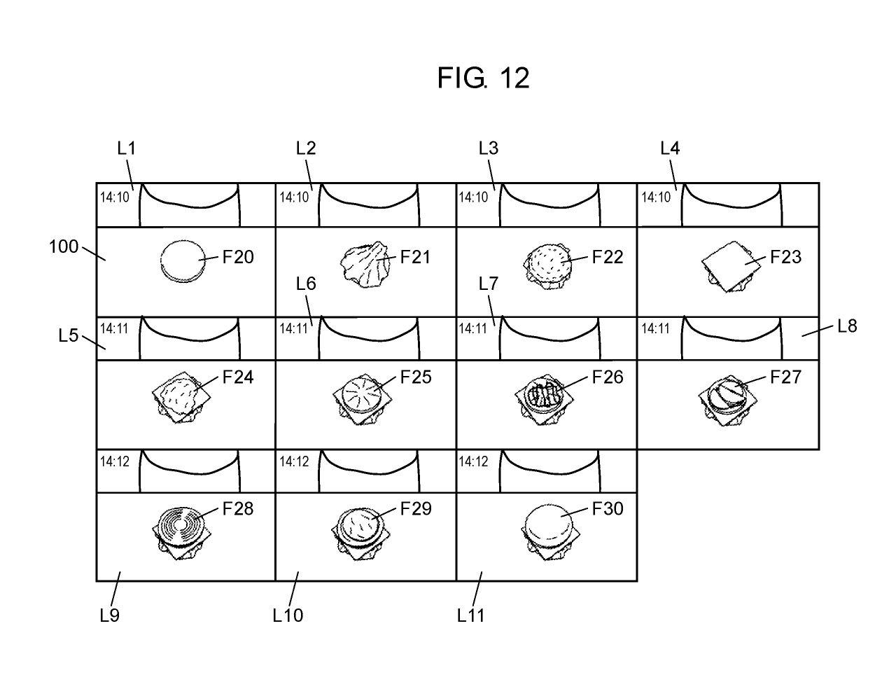

FIG. 12 illustrates record images L1 to L11 in which a cooking process of a hamburger made by using eleven kinds of ingredients F20 to F30. Every time the cooking person stacks a new ingredient, controller 3 causes first image capturer 4 to capture an image of the cooking space, and stores the record image captured by first image capturer 4 in storage device 8 in association with the time information and the identification information of the cooking person. If display of record images L1 to L11 in which a cooking process of a hamburger is recorded is requested, controller 3 reads record images L1 to L11 from storage device 8, and causes projector 2 to project record images L1 to L11 onto upper surface 101 of cooking table 100.

Here, image controller 32 controls projector 2 such that the image-capturing time (cooking time) of record images L1 to L11 is projected so as to overlap record images L1 to L11, and thus, it is possible to easily confirm the image-capturing time when record images L1 to L11 are captured. In FIG. 12, the image-capturing time (cooking time) of record images L1 to L11 is projected so as to overlap record images L1 to L11, but the elapsed time from start of cooking may be projected so as to overlap record images L1 to L11. In addition, two or more among the cooking data, the cooking time, and the elapsed time from start of cooking may be projected so as to overlap record images L1 to L11.

Since the cooking process can be grasped based on record images L1 to L11, traceability is improved. For example, it is possible to confirm later whether or not foreign matter is mixed in the cooking process and whether or not the cooking sequence is wrong, based on record images L1 to L11. In addition, record images L1 to L11 can also be used for confirming quality of cooking work, improving work content, and the like.

In the example of FIG. 12, the image-capturing times of record images L1 to L11 are projected so as to overlap record images L1 to L11, but the image-capturing date and time of record images L1 to L11 may be projected so as to overlap record images L1 to L11.

In addition, controller 3 may output the record image stored in storage device 8 to a computer terminal capable of communicating with controller 3, and can confirm the record image by using the computer terminal.

### (2.2.4) Display Operation of Cooking Guide

Kitchen support system 1 according to the present exemplary embodiment can also be used for dish plating, for example, for supporting cutting work of an ingredient used for cooking.

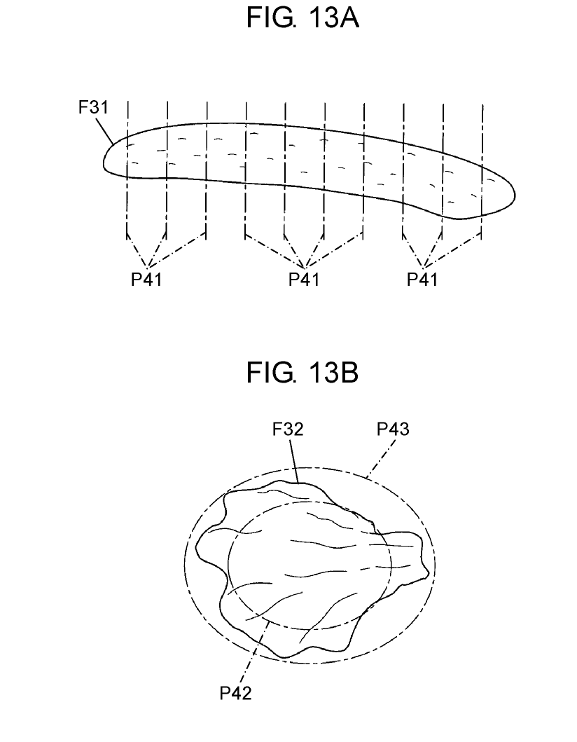

As illustrated in FIG. 13A, in a case where cucumber F31 is placed on upper surface 101 of cooking table 100, image controller 32 of controller 3 causes projector 2 to project auxiliary line P41 indicating a cut position at the time of cutting cucumber F31 onto cucumber F31.

If the cooking person utters a word instructing to perform a cooking guide of a cutting operation of cucumber F31, the word uttered by the cooking person is converted into an electric signal by microphone 6 and is input to controller 3, and voice recognition is performed in voice recognition module 312. Controller 3 starts displaying the cooking guide, according to the instruction input by voice of the cooking person. If object detector 33 of controller 3 detects a position of cucumber F31 placed on upper surface 101 of cooking table 100, image controller 32 controls projector 2 such that auxiliary line P41 is projected onto cucumber F31 at a constant interval (for example, an interval of 5 mm) The cooking person may cut cucumber F31 along auxiliary line P41 with a kitchen knife or the like, and thereby, cucumber F31 can be cut at a regular interval. In addition, since controller 3 can recognize a size of cucumber F31, based on the detection results of object detector 33, it is possible to adjust a start position, an interval, and the like of auxiliary line P41 projected onto cucumber F31, depending on a length and a thickness of cucumber F31.

In addition, kitchen support system 1 according to the present exemplary embodiment can also be used for managing a size of ingredients used for cooking. For example, as illustrated in FIG. 13B, in a case where cabbage F32 is used as an ingredient of dish, image controller 32 controls projector 2 controls projector 2 such that auxiliary line P42 representing a minimum limit of the size of cabbage F32 and auxiliary line P43 representing a maximum limit are projected onto cabbage F32. In a case where cabbage F32 used for cooking is smaller than auxiliary line P42 or larger than auxiliary line P43, the cooking person determines that cabbage F32 is out of standard and replaces the cabbage with another cabbage. Thereby, since an ingredient whose size is within a predetermined range can be used, it is possible to reduce variation in the size of an ingredient used for cooking.

As described above, when the object detected by object detector 33 is an ingredient, controller 3 controls projector 2 an auxiliary line for assisting cooking of dish is projected onto the ingredient.

In addition, kitchen support system 1 according to the present exemplary embodiment can also be applied to a dessert plating work and cooking support of the creation work of latte art.

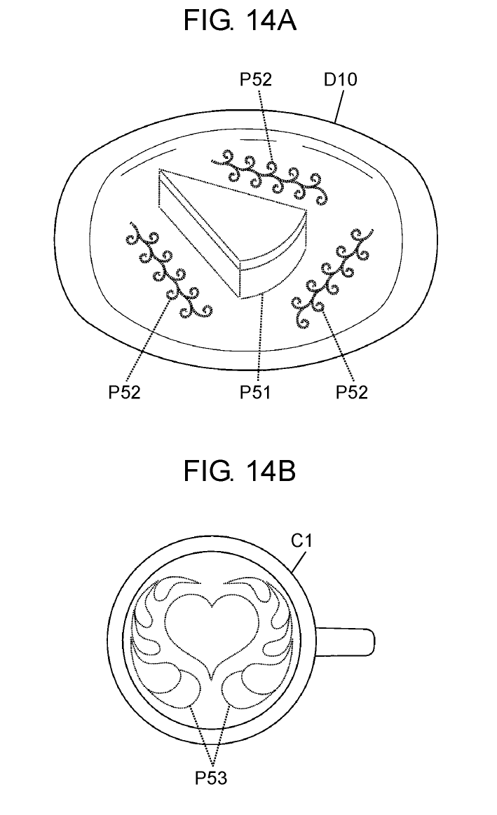

FIG. 14A illustrates an image to be projected in a case of supporting a dessert plating work. If controller 3 receives an instruction to support the dessert plating work, image controller 32 controls projector 2 such that cake image P51 plated on dessert tray D10 and image P52 of a pattern drawn on dessert tray D10 are projected onto dessert tray D10. The cooking person may plate the cake or draw a pattern by using a source such as chocolate, according to images P51 and P52 projected onto dessert tray D10, and thereby, even a cooking person who is not skillful in working can also easily serve a plating work.

In addition, FIG. 14B illustrates an image to be projected in a case where a creation work of the latte art is supported. For example, milk steamed on espresso is contained in cup C1. If receiving an instruction to support a creation work of latte art, image controller 32 controls projector 2 such that image P53 of a pattern to be created by latte art is projected onto top of the milk contained in cup C1. The cooking person may draw a pattern using a tool such as a pick in accordance with image P53, and even a cooking person who is not skillful in the work can easily perform the creation work of latte art.

As described above, when an object detected by object detector 33 is an ingredient, controller 3 controls projector 2 such that plating of dish is projected on the ingredient or around the ingredient.

### (3) Modification Example

Hereinafter, a kitchen support system according to a modified example of the above-described exemplary embodiment will be listed. The respective configurations of the modifications example which will be described below can be applied in combination with each configuration described in the above-described exemplary embodiment as appropriate.

In kitchen support system 1 according to the above-described exemplary embodiment, the cooking person cooks a single dish in cooking space S1, but a plurality of dishes (a plurality of dishes of the same type or a plurality of dishes of two or more kinds) may be cooked in parallel. In this case, image controller 32 may control projector 2 to project a plurality of cooking instruction images corresponding to the plurality of dishes onto cooking space S1.

A language of words in the image projected by projector 2 is not limited to Japanese but can be selected from a variety of languages such as English, Chinese, French, German, Spanish, Korean, and the like, and can be appropriately changed depending on the cooking person. In addition, a language by which the voice dialog unit 31 performs voice dialog is not limited to Japanese but can be selected from a variety of languages such as English, Chinese, French, German, Spanish, Korean, and the like.

Image controller 32 may control projector 2 to project an image for timer display onto upper surface 101 of cooking table 100. For example, image controller 32 may project an image that counts down time of fried food, simmered food, and the like onto upper surface 101 of cooking table 100 from projector 2, and can cook such as fried food, simmered food, and the like, while viewing the image of the countdown displayed on upper surface 101.

Image controller 32 may change dish relating information such as the cooking instruction image for each cooking person. For example, image controller 32 may change the dish relating information such as the cooking instruction image depending on a skill level of a cooking person, and may project the cooking instruction image of detailed content as the skill level of the cooking person is lower.

Infrared irradiator 51 of second image capturer 5 irradiates the entire distance measurement region with infrared light and a surface of infrared camera 52 receives light reflected from an object, but infrared camera 52 may receive the light reflected from the object at one point by sweeping a direction in which infrared irradiator 51 emits infrared light in the distance measurement region.

Infrared irradiator 51 and infrared camera 52 of second image capturer 5 measure a distance to the object by a TOF method, but the distance may be measured by a pattern irradiation method (light coding method), or the distance may be measured by a stereo camera.

Object detector 33 detects an object in cooking space S1 by using an image captured by RGB camera 53 and an image captured by infrared camera 52, but may detect the object in cooking space S1, based on the image captured by first image capturer 4. Object detector 33 can detect the object in cooking space S1, for example, by performing a background differentiation between the image captured by first image capturer 4 and a background image. In addition, object detector 33 may detect the object in cooking space S1, based on both the image captured by first image capturer 4 and the image captured by RGB camera 53. Furthermore, object detector 33 may detect the object in cooking space S1 by using at least one of the image captured by RGB camera 53, the image captured by infrared camera 52, and an image captured by first image capturer 4.

In kitchen support system 1 according to the above-described exemplary embodiment, controller 3 and a voice recognizer (voice recognition module 312) have separate housings, but controller 3 may have a function of the voice recognizer. Controller 3, the voice recognizer (voice recognition module 312), and projector 2 may be configured to have separate housings, or some configuration elements thereof may be dispersedly provided. That is, the configuration elements of kitchen support system 1 may be dispersedly provided in a plurality of housings. Furthermore, for example, even with respect to an individual configuration element such as second image capturer 5, it is not indispensable for kitchen support system 1 to be integrated in one housing, and individual configuration elements may be dispersedly provided in a plurality of housings.

Kitchen support system 1 according to the above-described exemplary embodiment is used in a kitchen of a fast-food store, but may be used in a kitchen of a restaurant, a hotel, or the like. In addition, kitchen support system 1 according to the exemplary embodiment may be used in a kitchen or the like for groceries provided in a back yard of a supermarket, and in this case, contents of cooking orders may be input to controller 3 by using an input device such as a computer terminal.

In addition, kitchen support system 1 according to the above-described exemplary embodiment is not limited to being used in a store or the like that receives cooking orders from a customer or the like, orders, and cooks, and may be used in an ordinary household. In this case, if a user of kitchen support system 1 determines contents of dishes to be cooked and input the contents to controller 3, controller 3 projects an image for cooking support onto a cooking space, according to the contents of dishes input by controller 3.

In addition, kitchen support system 1 according to the exemplary embodiment, projector 2 projects the dish relating image such as an order display image onto cooking space S1, but a part of the dish relating image may be displayed on another display device. Another display device is a liquid crystal display device, a tablet terminal or the like installed around cooking space S1. If image controller 32 displays the order display image, the cooking manual or the like on another display device, it is possible to reduce the number of images projected onto upper surface 101 of cooking table 100, except for the images projected onto an ingredient, a tray on which the ingredient is placed, a container for containing the ingredient, and the like, and it is possible to effectively use upper surface 101 of cooking table 100.

### (4) Summarization

As described above, kitchen support system (1) includes projector (2), voice recognizer (312), and controller (3). Projector (2) projects an image toward a cooking space in which cooking is performed. Voice recognizer (312) recognizes content of voice which is input. Controller (3) causes projector (2) to project a dish relating image relating to the dish including an order display image indicating order content of the dish. Controller (3) changes a dish relating image projected by projector (2), according to recognition results of voice recognizer (312).

According to the present disclosure, since projector (2) projects a dish relating image toward a cooking space, a cooking person can reduce the amount of movement of line of sight from a hand which is cooking when viewing the dish relating image during cooking, and thus, it is possible to increase work efficiency. The cooking person may issue an instruction by voice so as to change the dish relating image, and cooking can be performed by using both hands while issuing an instruction by voice, and thus, it is possible to increase work efficiency.

In addition, in kitchen support system (1) according to the present disclosure, controller (3), when a voice indicating that cooking of dish is completed is input to voice recognizer (312), an order display image is changed such that order content of dish whose cooking is completed is deleted from a dish relating image projected by projector (2).

According to this configuration, the cooking person may issue an instruction to delete the order content of dish by voice, and cooking is performed by using both hands while issuing an instruction by voice, and thus, it is possible to increase work efficiency.

In addition, kitchen support system (1) according to the present disclosure further includes an operation detector (34) which detects an operation of cooking of a cooking person. When an operation indicating that cooking of dish is completed is detected by operation detector (34), controller (3) changes an order display image such that order content of dish whose cooking is completed is deleted from a dish relating image projected by projector (2).

According to this configuration, a cooking person may issue an instruction such that order content of dish whose cooking is completed is deleted by operation, and may not operate operation buttons or the like by hand, and thus, it is hygienic.

In addition, kitchen support system (1) according to the present disclosure further includes object detector (33) which detects an object in a cooking space.

According to this configuration, it is possible for object detector (33) to detect an object in a cooking space projected by a projector.

In addition, in kitchen support system (1) according to the present disclosure, controller (3) controls projector (2) such that an order display image is projected onto a region not overlapping an object detected by object detector (33) in the cooking space.

According to this configuration, an order display image is projected onto a region not overlapping an object, and thus, the order display image is easily viewed.

In addition, in kitchen support system (1) according to the present disclosure, when an object detected by object detector (33) is an ingredient, controller (3) controls projector (2) such that a cooking instruction image instructing the cooking person a dish cooking method is projected onto the ingredient.

According to this configuration, a cooking person does cooking, according to a cooking instruction image projected onto an ingredient, it is possible for a cooking person who is not skillful in cooking to easily do cooking.

In addition, kitchen support system (1) according to the present disclosure further includes image capturer (6) and storage device (8). Image capturer (6) captures an image of a cooking space. Storage device (8) stores a record image captured by image capturer (6) in association with at least one of time information of the record image and identification information of a cooking person.

According to this configuration, traceability of a cooking work performed by a cooking person is improved based on a record image stored in storage device (8).

According to the present disclosure, it is possible to provide a kitchen support system capable of increasing work efficiency.

What is claimed is:

1. A kitchen support system comprising:
a projector that projects an image toward a cooking space in which cooking is performed;
a voice recognizer that recognizes content of voice which is input; and
a controller that controls the projector to project a dish relating image including an order display image indicating order content of dish, and changes the dish relating image which is projected by the projector in accordance with result of recognition of the voice recognizer.

2. The kitchen support system of claim 1,
wherein, when voice indicating that cooking of the dish is completed is input to the voice recognizer, the controller changes the order display image to delete order content of the dish, of which cooking is completed, from the dish relating image which is projected by the projector.

3. The kitchen support system of claim 1, further comprising:
an operation detector that detects an operation of a cooking person of the dish,
wherein, when an operation indicating that cooking of the dish is completed is detected by the operation detector, the controller changes the order display image to delete order content of the dish, of which cooking is completed, from the dish relating image which is projected by the projector.

4. The kitchen support system of claim 1,
wherein the controller controls the projector such that the projector projects a cooking instruction image which instructs a cooking sequence.

5. The kitchen support system of claim 4,
wherein, when voice requesting display of the cooking sequence is input to the voice recognizer, the controller controls the projector such that the projector projects the cooking instruction image which instructs the cooking sequence.

6. The kitchen support system of claim 1, further comprising:
an object detector that detects an object in the cooking space.

7. The kitchen support system of claim 6,
wherein the controller controls the projector such that the order display image is projected onto a region not overlapping the object which is detected by the object detector in the cooking space.

8. The kitchen support system of claim 6,
wherein, when the object which is detected by the object detector is an ingredient, the controller controls the projector such that an image which instructs a cooking method of the dish is projected onto the ingredient.

9. The kitchen support system of claim 6,
wherein, when the object which is detected by the object detector is an ingredient, the controller controls the projector such that an auxiliary line for assisting cooking of the dish is projected onto the ingredient.

10. The kitchen support system of claim 6,
wherein, when the object which is detected by the object detector is an ingredient, the controller controls the projector such that plating of the dish is projected onto the ingredient or around the ingredient.

11. The kitchen support system of claim 1, further comprising:
an image capturer that captures an image of the cooking space; and
a storage device that stores a record image, which is captured by the image capturer, in association with at least one of time information of the record image and identification information of a cooking person of the dish.
